(19) United States
(12) Patent Application Publication
(10) Pub. No.: US 2023/0281462 A1
(43) Pub. Date: Sep. 7, 2023

(54) DATA PROCESSING METHOD AND APPARATUS, DEVICE, AND MEDIUM

(71) Applicant: Tencent Cloud Computing (Beijing) Co., Ltd., Beijing (CN)

(72) Inventors: Jiaxiang WU, Beijing (CN); Fan BAI, Beijing (CN); Pengcheng SHEN, Beijing (CN); Shaoxin LI, Beijing (CN)

(21) Appl. No.: 18/306,197

(22) Filed: Apr. 24, 2023

Related U.S. Application Data
(63) Continuation of application No. PCT/CN2021/109314, filed on Jul. 29, 2021.

(30) Foreign Application Priority Data
Apr. 15, 2021 (CN) 202110407288.4

(51) Int. Cl. G06N 3/098

(52) U.S. Cl. CPC G06N 3/098

(57) ABSTRACT

Embodiments of this application provide a data processing method and apparatus, a device, and a medium. The method includes acquiring local model parameters corresponding to N local recognition models in an r^{th} synchronization period; the N local recognition models being respectively trained by different clients, N and r being positive integers greater than 1, and N denoting a quantity of the clients; performing parameter fusion on the local model parameters respectively corresponding to the N local recognition models to obtain a target global model corresponding to the r^{th} synchronization period; acquiring a historical global model corresponding to an r−1^{th} synchronization period; determining global federated momentum corresponding to the r^{th} synchronization period according to the historical global model and the target global model; and transmitting the global federated momentum to the N clients, the N clients respectively updating the associated local recognition models according to the global federated momentum.

### RELATED APPLICATIONS

This application is a continuation of PCT Application No. PCT/CN2021/109314, filed on Jul. 29, 2021, which in turn claim Chinese Patent Application No. 202110407288.4, filed on Apr. 15, 2021, and entitled “DATA PROCESSING METHOD AND APPARATUS, DEVICE, AND MEDIUM.” These two applications are incorporated herein by reference in its entirety.

### FIELD OF THE TECHNOLOGY

This application relates to the field of artificial intelligence (AI) technologies, and in particular, to a data processing method and apparatus, a device, and a medium.

### BACKGROUND OF THE DISCLOSURE

Federated learning is a new training method to solve the problem of data silos across departments and even across platforms. Model training may also be performed to obtain model parameters without giving one's own data. That is, joint training is performed while data privacy is ensured. A federated learning process needs to be supported by a large amount of data, and the data is distributed in different data holders. Therefore, various data holders are required for model building. When the data holders are united for model building, there is a need to perform parameter fusion on model parameters trained by the data holders.

### SUMMARY

Embodiments of this application provide a data processing method and apparatus, a device, and a medium, which can improve performance of an object recognition model and improve applicability of the object recognition model.

One aspect of this application provides a data processing method, performed by a service device, the method including acquiring local model parameters corresponding to N local recognition models in an r^{th} synchronization period; the N local recognition models being respectively trained by different clients, each client comprising sample data for training an associated local recognition model, both N and r being positive integers greater than 1, and N denoting a quantity of the clients; performing parameter fusion on the local model parameters respectively corresponding to the N local recognition models to obtain a target global model corresponding to the r^{th} synchronization period; acquiring a historical global model corresponding to an r−1^{th} synchronization period; the historical global model being generated based on local model parameters respectively uploaded by N clients in the r−1^{th} synchronization period; determining global federated momentum corresponding to the r^{th} synchronization period according to the historical global model and the target global model; the global federated momentum indicating training directions of the N local recognition models; and transmitting the global federated momentum to the N clients, the N clients respectively updating the associated local recognition models according to the global federated momentum.

Another aspect of this application provides a data processing method, performed by a user terminal, the method including uploading a local model parameter corresponding to the target local recognition model to a service device when a target local recognition model completes training of an r^{th} synchronization period, wherein the service device generates a target global model according to local model parameters respectively uploaded by N clients in the r^{th} synchronization period, and determines global federated momentum corresponding to the r^{th} synchronization period by combining the target global model with a historical global model corresponding to an r−1^{th} synchronization period; the target local recognition model being one of local recognition models corresponding to the N clients, the historical global model being generated based on local model parameters respectively uploaded by the N clients in the r−1^{th} synchronization period, the global federated momentum indicating training directions of the N local recognition models, both N and r being positive integers greater than 1; receiving the global federated momentum returned by the service device; and updating the target local recognition model according to the global federated momentum.

Another aspect of this application provides a non-transitory computer-readable storage medium, storing a computer program adapted to be loaded and executed by a processor to implement the data processing method according to the embodiments of this application.

According to the embodiments of this application, local model parameters respectively uploaded by the N clients are periodically acquired, a target global model and global federated momentum are generated according to the local model parameters, and the target global model and the global federated momentum are transmitted to the N clients to control training directions of the local recognition models respectively trained by the N clients, so that convergence directions of the local recognition models corresponding to the clients may not deviate too far from each other, which can improve performance of an object recognition model finally obtained and improve applicability of the object recognition model.

### BRIEF DESCRIPTION OF THE DRAWINGS

To describe the technical solutions in the embodiments of this application or in the related art more clearly, the following briefly introduces the accompanying drawings for describing the embodiments or the related art. Apparently, the accompanying drawings in the following description show merely some embodiments of this application, and a person of ordinary skill in the art may still derive other drawings from the accompanying drawings without creative efforts.

FIG. 1 is a schematic structural diagram of a network architecture according to an embodiment of this application;

FIG. 2 is a schematic diagram of a federated training scenario for local recognition models according to an embodiment of this application;

FIG. 3 is a schematic timing diagram of a data processing method according to an embodiment of this application;

FIG. 4 is a schematic diagram of a method for training local recognition models based on global federated momentum according to an embodiment of this application;

FIG. 5 is a schematic diagram of a method for training local recognition models based on global federated momentum according to an embodiment of this application;

FIG. 6 is a schematic structural diagram of a user identity authentication scenario according to an embodiment of this application;

FIG. 7 is a schematic diagram of a commodity recognition scenario according to an embodiment of this application;

FIG. 8 is a schematic structural diagram of a data processing apparatus according to an embodiment of this application;

FIG. 9 is a schematic structural diagram of a data processing apparatus according to an embodiment of this application;

FIG. 10 is a schematic structural diagram of a computer device according to an embodiment of this application; and

FIG. 11 is a schematic structural diagram of a computer device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

This application relates to artificial intelligence (AI) technologies, block chain technologies, and cloud technologies. Further, this application relates to face recognition under computer vision. Through federated learning, joint training is performed while data privacy of clients is ensured. An object recognition model obtained through joint training is applicable to each client. Schematically, the object recognition model obtained through training may be implemented as a model applied to a face recognition scenario. The object recognition model may be configured to recognize face images in the clients to obtain face recognition results. The face recognition results may be used as a basis for user identity verification.

This application relates to cloud storage under the cloud technologies. In this application, sample data held by the clients may be respectively stored on different logical volumes in a cloud storage system. That is, the sample data held by the clients may all be stored on a file system. For the sample data held by any client, the file system may divide the sample data into many parts. Each part is an object. The object may include sample data as well as a data identifier of the sample data. The file system writes each piece of sample data to a physical storage space of the logical volume, and the file system may record storage position information of the piece of sample data. In the case of federated training on the object recognition model, the client may request access to the sample data in the file system, and the file system may allow the client to access the sample data according to the storage position information of the sample data. In some embodiments, the sample data held by any client may be multimedia sample data.

All the clients and the service device in this application may be block chain nodes belonging to a same block chain system. During the federated training on the object recognition model, uploaded local model parameters, a target global model, and global federated momentum may be stored on a block chain to ensure traceability of a parameter fusion process during the federated training.

This application is applicable to the field of security and protection monitoring (such as security monitoring). For example, in an office region where access is restricted, such as an enterprise or a government agency, there is a need to verify access permissions of persons in and out. Only persons with access permissions can enter, and persons without access permissions cannot enter. An object recognition model with a permission verification function can be trained through the data processing method according to the embodiments of this application. Schematically, a process of performing permission verification through the object recognition model may be implemented as follows: Information of a specific person that can pass is collected to obtain target face image data. When a person waiting to pass wants to enter the office region, face image data of the person waiting to pass may be collected and used as a face image to be recognized, and the face image to be recognized is inputted into the object recognition model which performs feature extraction on the face image to be recognized to obtain a verification result. The verification result is compared with the target face image data. It is determined that the person waiting to pass can enter the office region if face image data corresponding to the verification result exists in the target face image data. It is determined that the person waiting to pass cannot enter the office region if the face image data corresponding to the verification result does not exist in the target face image data.

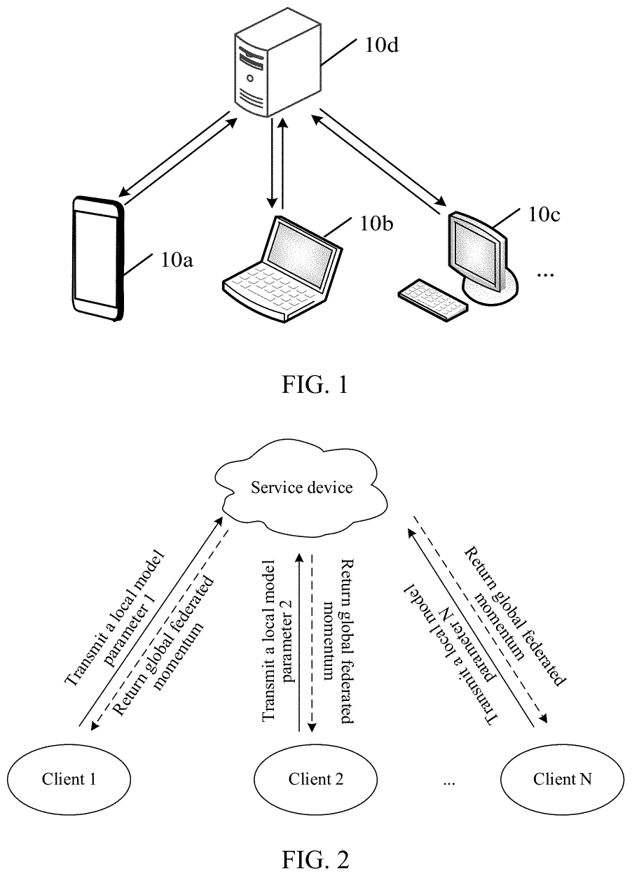

FIG. 1 is a schematic structural diagram of a network architecture according to an embodiment of this application. As shown in FIG. 1, the network architecture may include a server 10d and a user terminal cluster. The user terminal cluster may include one or more user terminals. A quantity of the user terminal is not limited herein. As shown in FIG. 1, the user terminal cluster may specifically include a user terminal 10a, a user terminal 10b, a user terminal 10c, and the like. The server 10d may be a standalone physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an AI platform. The user terminal 10a, the user terminal 10b, the user terminal 10c, and the like may all include: an intelligent terminal with a data processing function such as a smart phone, a tablet computer, a notebook computer, a palm computer, a mobile Internet device (MID), a wearable device (such as a smart watch or a smart bracelet), or a smart TV. As shown in FIG. 1, the user terminal 10a, the user terminal 10b, the user terminal 10c, and the like may respectively perform a network connection with the server 10d, so that each user terminal can perform data interaction with the server 10d through the network connection.

As shown in FIG. 1, a client may be integrated in each user terminal in the user terminal cluster. One or more clients may be integrated in each user terminal. For example, different clients may be integrated in a same user terminal. The different clients may hold different multimedia data, and the multimedia data held by the different clients may all be used for training the object recognition model. In some embodiments, the multimedia data held by the different clients in this application is data of a same type. For example, all the multimedia data held by the different clients is face image data. The training of the object recognition model requires a large amount of sample data, and the multimedia data held by the different clients may involve private information or confidential information. In other words, the multimedia data held by each client may be private or interactive. Therefore, the training of the object recognition model may be completed by federated training. In other words, each client may use the multimedia data held by the client as sample data for training the object recognition model. During the model training, training models corresponding to the clients may be called local recognition models. The clients train the corresponding local recognition models based on multimedia sample data held by the clients. Different clients may periodically synchronize model parameters, and model parameters obtained by the clients through training may be called local model parameters. That is, each client may periodically upload the local model parameter obtained through training to the server 10d. The server 10d may periodically gather the local model parameters respectively uploaded by the clients, and perform parameter fusion on the local model parameters respectively uploaded by the clients to obtain a target global model corresponding to each synchronization period. The target global model is a model with fused local model parameters. Then, the target global model may be delivered to the clients. The clients may continue to train the corresponding local recognition models according to the target global model until a training termination condition is met, to obtain a trained local recognition model, i.e., the object recognition model. The training termination condition may mean that local recognition models after the parameter update reach convergence, or the target global model reaches convergence, or a quantity of training iterations reaches a preset maximum quantity of iterations. The object recognition model may be configured to recognize an object of a target object type included in the multimedia data, which can improve a generalization recognition effect of the object recognition model. The target object type may include, but is not limited to, faces, plants, commodities, pedestrians, various animals, and various scenarios.

FIG. 2 is a schematic diagram of a federated training scenario for local recognition models according to an embodiment of this application. A client 1 shown in FIG. 2 may be a client integrated in the above user terminal 10a shown in FIG. 1 and having a recognition model federated training permission, a client 2 may be a client integrated in the above user terminal 10b shown in FIG. 1 and having a recognition model federated training permission, and a client N may be a client integrated in the above user terminal 10c shown in FIG. 1 and having a recognition model federated training permission. A service device may be the above server 10d shown in FIG. 1. As shown in FIG. 2, a quantity of clients participating in recognition model federated training is N. N may be a positive integer greater than 1. For example, N may be 2, 3, or the like. For example, the object recognition model may be configured for face recognition. All the clients may hold face sample data for recognition model training, and the face sample data held by the clients is independent from each other. For example, to ensure the privacy of data, the client 1 may not share the face sample data held by the client to other devices (such as the client 2, the client N, and the service device). Therefore, each client can use the face sample data held by the client to locally perform local training on the object recognition model, that is, locally perform training on the local recognition model. A model parameter obtained by the client through local training may be called a local model parameter. The clients performing model training may be different clients in a same terminal or clients in different terminals.

The face sample data used by each client is different. Therefore, each client needs to periodically upload a local model parameter to the service device, so that the service device can synchronize local model parameters obtained by N clients through training, that is, perform parameter fusion on the local model parameters obtained by the N clients through training, to obtain a target global model. For example, if every 50 training iterations (also called a quantity of times of training, or a quantity of training steps) is set as a synchronization period, each client needs to upload a local model parameter to the service device once every 50 training iterations. As shown in FIG. 2, when a quantity of training iterations locally performed by the client 1 on the local recognition model reaches 50, the client 1 may transmit a model parameter 1 obtained after the 50^{th} training iteration (that is, a local model parameter obtained by the client 1 after the 50^{th} training iteration) to the service device. Similarly, when the quantity of training iterations locally performed by the client 2 on the local recognition model reaches 50, the client 2 may transmit a model parameter 2 obtained after the 50^{th} training iteration to the service device. The client N may transmit a model parameter N obtained by the client after the 50^{th} training iteration to the service device. The service device, after receiving the local model parameters (including the model parameter 1, the model parameter 2, . . . , and the model parameter N) respectively transmitted by the N clients and obtained after the 50^{th} training iteration, may perform parameter fusion on the N local model parameter to obtain a fused model parameter, to obtain the target global model. Afterwards, the service device performs calculation based on the target global model to obtain global federated momentum, and then may return the target global model and the global federated momentum to the clients. Each client may update the local model parameter according to the target global model and the global federated momentum returned by the service device, and continue to train a local recognition model after the parameter update. When the quantity of training iterations performed by each client on the local recognition model reaches 100, there is a need to repeat the above operation to obtain a target global model corresponding to next synchronization period and continue to train the local recognition model based on the target global model until the local recognition model meets the above training termination condition. A local model parameter in this case is saved. The local recognition model including the current local model parameter may be determined as a trained model. In this application, the trained local recognition model may be determined as the object recognition model.

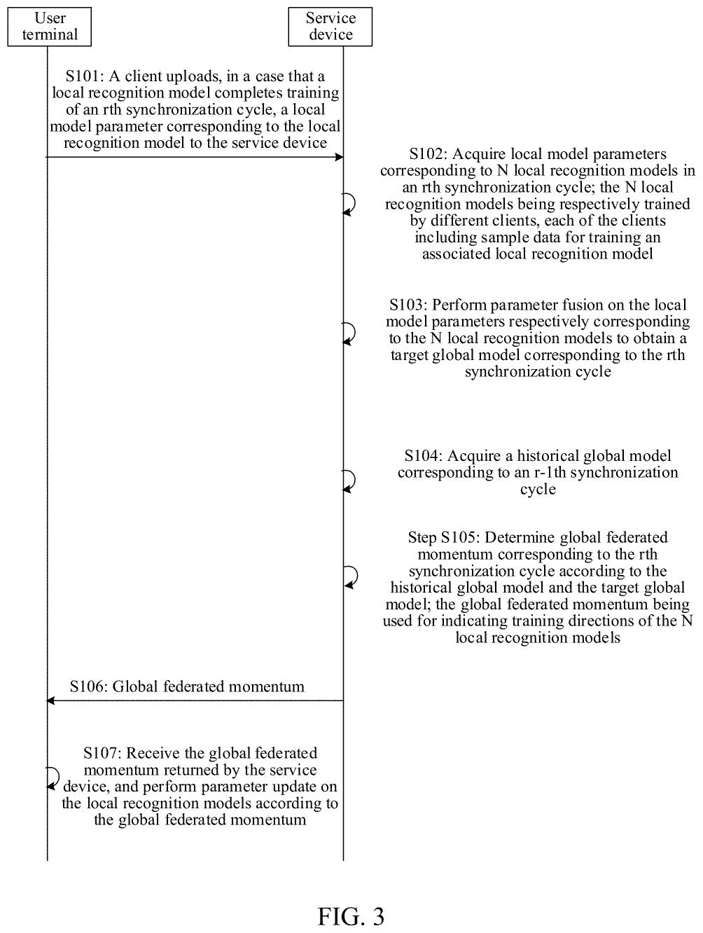

FIG. 3 is a schematic timing diagram of a data processing method according to an embodiment of this application. The data processing method may be interactively performed by a user terminal and a service device. The user terminal may be any one or more user terminals in the above user terminal cluster shown in FIG. 1. The service device may be a standalone server (such as the above server 10d shown in FIG. 1), a server cluster including a plurality of servers, a user terminal, or the like. As shown in FIG. 3, the data processing method may include the following steps:

Step S101: The user terminal uploads, when a local recognition model completes training of an r^{th} synchronization period, a local model parameter corresponding to the local recognition model to the service device.

In some embodiments, the user terminal uploads, when the local recognition model completes training of the r^{th} synchronization period, a local model parameter of the local recognition model corresponding to one or more integrated clients to the service device.

Taking any one (target client) of the N clients as an example, when a target local recognition model completes training of the r^{th} synchronization period, the target client uploads a local model parameter corresponding to the target local recognition model to the service device through a corresponding user terminal.

When the sample data held by the N (N may be a positive integer greater than 1) clients is data of a same type and the sample data held by the N clients involves data privacy and data security, it indicates that the sample data held by the N clients cannot be aggregated. If there is a need to use the sample data held by the N clients to train the object recognition model, the object recognition model may be trained by federated training on the premise of ensuring data security and privacy of the clients. In some embodiments, in the federated training, the multimedia data held by the N clients may be used as the sample data. The multimedia sample data may include an object of a target object type. The object of the target object type refers to data corresponding to the target object type. For example, the multimedia sample data may include face image data, user financial data, surveillance video data, user commodity data, and the like. The target object type may include object types such as faces, pedestrians, and commodities. In the embodiments of this application, the data processing method according to this application is described with an example in which the sample data is multimedia sample data.

The data processing method according to this application is described with an example in which the multimedia sample data is face image data: The face sample data used by each client is different. Therefore, each client needs to periodically upload a local model parameter to the service device (such as the above service device in the embodiment corresponding to FIG. 2), so that the service device can synchronize local model parameters obtained by N clients through respective training, that is, perform parameter fusion on the local model parameters obtained by the N clients through training, to obtain the target global model. Each client may use the multimedia data held by the client to independently train a recognition model locally (the recognition model independently trained by each client may be called a local recognition model). Each client may periodically upload the local model parameter obtained through independent training to the service device through the corresponding user terminal, so that the service device can synchronize the parameters in the local recognition models. In the embodiments of this application, the synchronization period may be set according to an actual requirement. For example, the synchronization period may be set to K times of training (also called a quantity of training steps), indicating that the local model parameter corresponding to the local recognition model needs to be uploaded to the service device for synchronization each time the local recognition model in the client is iteratively trained K times. K is a positive integer greater than 1. For example, K may be 100, 400, 1600, or other values. The r^{th} synchronization period means that the clients upload respective local model parameters to the service device for the r^{th} time. r may be a positive integer greater than 1. For example, r may be 2, 3, or the like. If the synchronization period K is 100, the clients may upload local model parameters obtained after the 100^{th} training to the service device when the quantity of times of training on the local recognition model corresponding to each of the N clients reaches 100. In this case, the service device receives the local model parameters transmitted by the clients for the first time (r is 1 in this case). The clients may upload local model parameters obtained after the 200^{th} training to the service device when the quantity of times of training on the local recognition model corresponding to each client reaches 200. In this case, the service device receives the local model parameters transmitted by the clients for the second time (r is 2 in this case). The rest may be deduced by analogy. In other words, r in the embodiments of this application may denote a quantity of times the service device receives the local model parameters transmitted by the clients.

It may be understood that a training process of each of the N clients for the local recognition model is similar, but only the multimedia sample data used is different. In the following, any client is selected from the N clients as a target client. The training process for the local recognition model is described by taking the target client as an example. A local recognition model independently trained locally by the target client may be called a target local recognition model. The target local recognition model may be any of the local recognition models corresponding to the N clients. The target client may use the multimedia sample data held by the target client to train the target local recognition model. A local model parameter corresponding to the target local recognition model is uploaded to the service device through the corresponding user terminal when the target local recognition model completes training of the r^{th} synchronization period. r denotes a quantity of times the clients upload local model parameters corresponding to respective local recognition models.

In some embodiments, a specific method in which the target client trains the target local recognition model may include:
acquiring the multimedia sample data, and inputting the multimedia sample data into the target local recognition model;
outputting an object space feature corresponding to the multimedia sample data through the target local recognition model;
determining a function value of a training loss function corresponding to the target local recognition model according to the object space feature and label information corresponding to the multimedia sample data; and
determining a training gradient of the target local recognition model according to the function value of the training loss function, and performing parameter update on the target local recognition model according to the training gradient and a training learning rate corresponding to the target local recognition model.

During the training of the target local recognition model, the target client may read the multimedia sample data held by the target client, and compose the read multimedia sample data into a batch processing file (batch). The multimedia sample data included in the batch may be inputted to the target local recognition model. A set or a batch of multimedia sample data is used for model training of one synchronization period on the target local recognition model, and each set or batch of multimedia sample data is marked. For example, the batch including the multimedia sample data used during the training of a p^{th} synchronization period may be marked as Xₚ. The target client, after acquiring the multimedia sample data, may acquire label information corresponding to the multimedia sample data. The label information may be obtained by manually labeling the multimedia sample data. The label information corresponding to the multimedia sample data may be used as an expected result of recognition of the target local recognition model on the multimedia sample data. The target client, after inputting the multimedia sample data into the target local recognition model, may obtain the object space feature corresponding to the multimedia sample data extracted by the target local recognition model, and determine the function value of the training loss function corresponding to the target local recognition model according to the label information corresponding to the multimedia sample data and the object space feature corresponding to the multimedia sample data. The object space feature is used for indicating an actual prediction result of the target local recognition model for the multimedia sample data. The function value of the training loss function corresponding to the target local recognition model is determined by comparing a difference between the object space feature and the label information. Further, the target client may determine the training gradient of the target local recognition model according to the function value of the training loss function corresponding to the target local recognition model. The target client may perform parameter update on the target local recognition model according to the training gradient and the training learning rate corresponding to the target local recognition model, to train the target local recognition model.

In some embodiments, during a round of training, a quantity of times of training corresponding to the target local recognition model is counted while parameter update is performed on the target local recognition model. The target client may upload a local model parameter after the last parameter update during the round of training to the service device when the quantity of times of training corresponding to the target local recognition model reaches a quantity of times corresponding to the synchronization period. Local model parameters uploaded by different clients to the service device may be represented by different identification information. A local model parameter uploaded by the above target client may be expressed as θᵢ, i∈{1, . . . N}.

The training loss function corresponding to the target local recognition model may be a classification function, such as a softmax function (a normalized multi-classification function that assigns a probability value to each output classification result, indicating a possibility of belonging to each category, in which input is a vector, output is also a vector, a value of each element in the output vector is between 0 and 1, and a sum of the elements is 1) or a sigmoid function (a binary classification function that converts an output classification result into a probability for classification, where input data of the sigmoid function may belong to any real value, and an output result ranges from 0 to 1), or may be one of a CosFace function (which may maximize an inter-class difference and minimize an intra-class difference through normalization and maximization of a cosine decision boundary) and an ArcFace function (which optimizes an inter-class difference from an arccosine space, making a cos value smaller in a monotone interval by adding m to an included angle) for optimization of a face recognition problem, or the like. After the determination of the function value of the training loss function of the target local recognition model, the training gradient corresponding to the target local recognition model may be calculated according to a chain rule. Schematically, a calculation formula of the training gradient corresponding to the target local recognition model may be shown by the following formula (1):

g=∇ [symbol] (θᵢ,xₖ) (1)
where g in the formula (1) denotes the training gradient of the target local recognition model, ∇ denotes gradient calculation, [symbol] denotes the training loss function corresponding to the target local recognition model, θᵢ denotes the local model parameter corresponding to the target local recognition model, and xₖ denotes the multimedia sample data for training the target local recognition model.

In some embodiments, the target local recognition model may be a convolutional neural network (CNN). Feature extraction is performed on the multimedia sample data through the CNN to obtain the object space feature corresponding to the multimedia sample data. The target local recognition model may include a convolution layer, a normalization layer, and a pooling layer when the target local recognition model is the CNN. A specific method in which the target client inputs the multimedia sample data into the target local recognition model, and outputs the object space feature corresponding to the multimedia sample data through the target local recognition model may include: convoluting, in the convolution layer of the target local recognition model, the multimedia sample data to obtain convolution feature information corresponding to the multimedia sample data; normalizing, in the normalization layer, the convolution feature information to obtain normalized convolution feature information; and pooling, in the pooling layer, the normalized convolution feature information to obtain the object space feature corresponding to the multimedia sample data. The CNN is a feedforward neural network and may be used for feature extraction on a multimedia sample image.

Schematically, the target client may input the multimedia sample data into the target local recognition model, and convolute, in the convolution layer, the multimedia sample data through a plurality of convolution kernels in the convolution layer to obtain the convolution feature information corresponding to the multimedia sample data. The convolution layer includes one or more convolution kernels (which may also be called a filter, or a receptive field). Convolution operation refers to matrix multiplication operation between the convolution kernel and a sub-matrix located at different positions of an input vector. A row count Hₒᵤₜ and a column count Wₒᵤₜ of an output matrix after the convolution operation are jointly determined by a size of the input vector, a size of the convolution kernel, a stride, and boundary padding. That is, Hₒᵤₜ=(Hᵢₙ−Hₖₑᵣₙₑₗ+2*padding)/stride+1, and Wₒᵤₜ=(Wᵢₙ−Wₖₑᵣₙₑₗ+2*padding)/stride+1. Hᵢₙ, Hₖₑᵣₙₑₗ respectively denote a quantity of input vectors and a row count of the convolution kernel; Wᵢₙ, Wₖₑᵣₙₑₗ respectively denote a dimension count of each input vector and a column count of the convolution kernel. After the convolution feature information corresponding to the multimedia sample data is obtained, in the normalization layer, the convolution feature information may be normalized to obtain normalized convolution feature information. The normalization is used for solving comparability between feature indexes. After the normalization, the indexes are in a same order of magnitude, facilitating comprehensive comparison. In the pooling layer, the normalized convolution feature information is pooled to obtain the object space feature corresponding to the multimedia sample data.

Step S102: The service device acquires local model parameters corresponding to N local recognition models in an r^{th} synchronization period; the N local recognition models being respectively trained by different clients, each of the clients including sample data for training an associated local recognition model, both N and r being positive integers greater than 1, and N denoting a quantity of the clients.

The N clients may respectively upload local model parameters corresponding to the associated local recognition models to the service device through the corresponding user terminal when the local recognition model in each of the N clients completes training of the r^{th} synchronization period. Correspondingly, the service device may acquire the local model parameters corresponding to the N local recognition models in the r^{th} synchronization period. The N local recognition models are respectively trained by different clients. Each of the clients includes sample data for training the associated local recognition model.

In some embodiments, the sample data is multimedia sample data. The multimedia sample data includes an object of a target object type. For example, the multimedia sample data all includes data indicating faces, commodities, animals, or the like. For example, all the multimedia sample data for training the associated local recognition models included in the clients is face sample data. The clients use the face sample data to train the local recognition models to obtain object recognition models for face recognition. For example, if the quantity of times of periodic training in the r^{th} synchronization period is 50, when a quantity of times of training of the local recognition model associated with each of the N clients in the r^{th} synchronization period reaches 50, a local model parameter corresponding to the local recognition model obtained through the 50^{th} training is uploaded to the service device. The quantity of times of training in each synchronization period may be the same or different, which may be set according to a specific requirement and is not limited in the embodiments of this application.

Step S103: The service device performs parameter fusion on the local model parameters respectively corresponding to the N local recognition models to obtain a target global model corresponding to the r^{th} synchronization period.

The multimedia sample data for training the associated local recognition models in the clients includes data of the target object type, such as face data, commodity data, and monitored item data. Therefore, the local recognition models trained by the clients have a same data processing function, such as face recognition or commodity recognition. However, data between the clients is independent of each other and cannot be shared. Therefore, the service device may perform parameter fusion on the local model parameters respectively uploaded by the N local recognition models in the r^{th} synchronization period to obtain the target global model corresponding to the r^{th} synchronization period, o solve the problem of slow and unstable convergence of model training due to inconsistent optimization directions of the local recognition models associated with the clients caused by differences in the multimedia sample data between the clients during the training, that is, solve the problems such as inapplicability to actual application scenarios due to poor model performance caused by client drift, thereby improving efficiency of the model training to enable better performance of a model finally trained.

In some embodiments, a process of performing, by the service device, parameter fusion on the local model parameters respectively corresponding to the N local recognition models to obtain a target global model corresponding to the r^{th} synchronization period may be implemented as follows:
acquiring M local model parameters from the local model parameters respectively corresponding to the N local recognition models, M being a positive integer less than N;
acquiring training influence weights respectively corresponding to the M local model parameters; and
performing weighted summation on the training influence weights and the M local model parameters to obtain a fusion model parameter, and determining a model carrying the fusion model parameter as the target global model.

Schematically, the service device, after receiving the local model parameters respectively transmitted by the N clients, may select, from the N local model parameters, the M local model parameters randomly or in a specified order for parameter fusion, to prevent the problem of low efficiency of the parameter fusion caused by a huge number of the local model parameters uploaded by the N clients, thereby improving the efficiency of the parameter fusion. The training influence weights respectively corresponding to the M local model parameters, i.e., training influence weights corresponding to the local model parameters, are acquired. The training influence weights respectively corresponding to the M local model parameters may be the same or different. The training influence weights of the local model parameters may be set according to a specific requirement, which is not limited in the embodiments of this application. According to the training influence weights respectively corresponding to the M local model parameters, weighted summation is performed on the training influence weights respectively corresponding to the M local model parameters to obtain the fusion model parameter, and the model carrying the fusion model parameter is determined as the target global model. In addition, the M local model parameters are selected from the N local model parameters, and the target global model is generated according to the M local model parameters and the training influence weights corresponding to the local model parameters, which can increase randomness of model parameter fusion, thereby improving a generalization effect of the object recognition model obtained through training.

When the service device performs parameter fusion on the local model parameters uploaded by the clients to generate a model parameter of the target global model, calculation may be performed using the following formula (2):

Θᵣ=Σᵢ₌₁^{N}wᵢθᵢ (2)
where Θᵣ in the formula (2) denotes the model parameter of the target global model corresponding to the r^{th} synchronization period, N denotes a total quantity of the local recognition models associated with the clients (one client corresponds to one local recognition model), wᵢ denotes a weight corresponding to a local model parameter of an i^{th} local recognition model in the r^{th} synchronization period, and θᵢ denotes the local model parameter of the i^{th} local recognition model.

In some embodiments, the weight w corresponding to the local model parameter of each local recognition model in the r^{th} synchronization period may be the same or different, which may be customized according to an actual requirement and is not limited in the embodiments of this application. When the weight w corresponding to the local model parameter of each local recognition model is the same and the model parameter of the target global model is generated, calculation may be performed using the following formula (3):

$${Θ}_{r} = \frac{1}{N} {\sum }_{i}^{N} {θ}_{i} \qquad ( 3 )$$

where Θᵣ in the formula (3) denotes the model parameter of the target global model corresponding to the r^{th} synchronization period, N denotes a total quantity of the local recognition models associated with the clients (one client corresponds to one local recognition model), and θᵢ denotes the local model parameter of the i^{th} local recognition model.

Step S104: The service device acquires a historical global model corresponding to an r−1^{th} synchronization period.

The historical global model is generated based on local model parameters uploaded by the N clients in the r−1^{th} synchronization period (a model parameter of the historical global model may be expressed as Θᵣ₋₁). A process of generating the historical global model may be obtained with reference to the process of generating the target global model. Details are not described herein again.

Step S105: The service device determines global federated momentum corresponding to the r^{th} synchronization period according to the historical global model and the target global model; the global federated momentum being used for indicating training directions of the N local recognition models.

In some embodiments, the service device may acquire the historical global model of the N local recognition models in the r−1^{th} synchronization period. The r−1^{th} synchronization period refers to a previous synchronization period of the r^{th} synchronization period. The historical global model is generated based on the local model parameters respectively uploaded by the N clients in the r−1^{th} synchronization period. Each historical synchronization period corresponds to a historical global model. The service device may determine the global federated momentum corresponding to the r^{th} synchronization period according to the historical global model in the r−1^{th} synchronization period and the target global model corresponding to the r^{th} synchronization period. The global federated momentum is used for indicating the training directions of the N local recognition models.

In some embodiments, the service device, after generating the target global model in the r^{th} synchronization period according to the local model parameters uploaded by the clients and acquiring the historical global model in the r−1^{th} synchronization period, may determine a global model gradient according to the target global model and the historical global model. The global model gradient is used for indicating the training directions of the local recognition models associated with the clients. Schematically, a calculation method of the global model gradient determined by the service device according to the target global model and the historical global model may be expressed as the following formula (4):

$${G}_{r} = \frac{{Θ}_{r - 1} - {Θ}_{r}}{{η}_{r}} - β {M}_{r - 1}^{Θ} \qquad ( 4 )$$

where Gr in the formula (4) denotes the global model gradient in the r^{th} synchronization period, Θᵣ₋₁ denotes a model parameter of the historical global model corresponding to the r−1^{th} synchronization period, Or denotes a model parameter of the target global model corresponding to the r^{th} synchronization period, ηᵣ denotes learning rates of the local recognition models in the clients corresponding to the r^{th} synchronization period, Mᵣ₋₁^{Θ} denotes global federated momentum corresponding to the r−1^{th} synchronization period, and β denotes a parameter of the global federated momentum corresponding to the r−1^{th} synchronization period. The parameter R may be set according to an actual application requirement.

In some embodiments, determining, by the service device, global federated momentum corresponding to the r^{th} synchronization period may include:
acquiring training learning rates of the N local recognition models in the r^{th} synchronization period and a model parameter difference between the target global model and the historical global model; and
determining a ratio of the model parameter difference to the training learning rates as the global federated momentum.

The training learning rates refer to learning speeds associated with the clients. The service device may determine learning speeds corresponding to the local recognition models in the clients according to the training learning rates. For example, during training of a local recognition model, a smaller quantity of times of training of the local recognition model indicates that the local recognition model is farther from the training termination condition and the training learning rate set during the training of the local recognition model is larger. A larger quantity of times of training of the local recognition model indicates that the local recognition model is closer to the training termination condition and the training learning rate set during the training of the local recognition model is smaller. In other words, the training learning rate used during the training may be adaptively reduced as the quantity of times of training of the local recognition model increases.

The service device may determine the global federated momentum corresponding to the r^{th} synchronization period according to the following formula (5).

$${M}_{r}^{Θ} = {M}_{r - 1}^{Θ} + {G}_{r} = \frac{{Θ}_{r} - {Θ}_{r - 1}}{{η}_{r}} \qquad ( 5 )$$

where M=ᵣ^{Θ} in the formula (5) denotes the global federated momentum corresponding to the r^{th} synchronization period, Θᵣ denotes a model parameter corresponding to the target global model in the r^{th} synchronization period, Θᵣ₋₁ denotes a model parameter corresponding to the historical global model in the r−1^{th} synchronization period, and ηᵣ denotes the training learning rates of the N local recognition models in the r^{th} synchronization period. In a same synchronization period, the training learning rates used by N local recognition models may be the same.

Step S106: The service device transmits the global federated momentum to the N clients, so that the N clients respectively perform parameter update on the associated local recognition models according to the global federated momentum.

The multimedia sample data between the clients cannot be shared, resulting in inconsistent optimization directions of the local recognition models associated with the clients. Therefore, a training direction of the local recognition model associated with each of the N clients may be indicated through the global federated momentum. In this way, convergence directions of the local recognition models associated with the clients may not deviate too far from each other, to ensure application effects of the obtained object recognition model in the clients.

Step S107: The clients receive the global federated momentum returned by the service device, and perform parameter update on the local recognition models according to the global federated momentum.

For any client (target client) in the clients, the target client receives the global federated momentum returned by the service device, and performs parameter update on the target local recognition model according to the global federated momentum.

In some embodiments, the target local recognition model is trained based on multimedia sample data. The multimedia sample data includes an object of a target object type.

An object recognition model is obtained in response to the target local recognition model reaching a training termination condition. The object recognition model is configured to recognize the object of the target object type included in the multimedia sample data.

The target client may be any one of the N clients. In other words, each of the N clients may receive the global federated momentum returned by the service device, perform parameter update on the local recognition model associated therewith according to the global federated momentum, and obtain an object recognition model after the local recognition model associated therewith reaches the training termination condition. The object recognition models corresponding to the N clients may all be configured to recognize the object of the target object type included in the multimedia sample data.

In some embodiments, performing, by the clients, parameter update on the target local recognition model according to the global federated momentum may include:
acquiring a training gradient and a training learning rate corresponding to the target local recognition model in the r^{th} synchronization period;
acquiring a quantity of times of periodic training of the target local recognition model in the r^{th} synchronization period;
determining a ratio of the global federated momentum to the quantity of times of periodic training as unit federated momentum; and
performing parameter update on the target local recognition model according to the training learning rate, the training gradient, and the unit federated momentum.

Schematically, taking a target client corresponding to the target local recognition model as an example, the target client may acquire the training gradient and the training learning rate corresponding to the target local recognition model in the r^{th} synchronization period. The training gradient corresponding to the target local recognition model in the r^{th} synchronization period may be calculated according to the formula (1). Details are not described herein again. The target client may acquire the quantity of times of periodic training of the target local recognition model in the r^{th} synchronization period, acquire the ratio of the global federated momentum to the quantity of times of periodic training, and determine the ratio of the global federated momentum to the quantity of times of periodic training as the unit federated momentum. The target client, after obtaining the unit federated momentum, may determine a product between a sum of the unit federated momentum and the training gradient corresponding to the target local recognition model in the r^{th} synchronization period and the training learning rate corresponding to the target local recognition model in the r^{th} synchronization period. The target client may acquire a difference between a model parameter of the target local recognition model and the above product, and perform parameter update on the target local recognition model according to the difference. After the parameter update on the target local recognition model, an initial model parameter of a target local recognition model for next synchronization period is obtained. That is, in an r+1^{th} synchronization period, the target local recognition model with the initial model parameter corresponding to the r+1^{th} synchronization period is trained. When the quantity of times of training reaches a quantity of times of periodic training of the r+1^{th} synchronization period, a local model parameter corresponding to the target local recognition model reaching the quantity of times of periodic training of the r+1^{th} synchronization period is also uploaded to the service device. The service device may obtain global federated momentum corresponding to the r+1^{th} synchronization period according to local model parameters uploaded by the N clients, and then transmit the global federated momentum corresponding to the r+1^{th} synchronization period to the N clients. The N clients may perform, according to the global federated momentum corresponding to the r+1^{th} synchronization period, parameter update on local recognition models associated therewith, to perform the above operations cyclically. When the target local recognition model after the parameter update meets the training termination condition, the target local recognition model meeting the termination condition is determined as the object recognition model.

In some embodiments, a process of performing parameter update on the target local recognition model according to the global federated momentum may be expressed by the following formula (6):

$${θ}_{j} = {θ}_{j - 1} - {η}_{r} ( g + \frac{{M}_{r}^{Θ}}{K} ) \qquad ( 6 )$$

where θᵢ in the formula (6) denotes a model parameter corresponding to the target local recognition model after the parameter update in the target client, θⱼ₋₁ denotes a model parameter corresponding to the target local recognition model prior to the parameter update in the target client, ηᵣ denotes a training learning rate of the target local recognition model in the target client in the r^{th} synchronization period, g denotes a training gradient of the target local recognition model, Mᵣ^{Θ} denotes global federated momentum corresponding to the r^{th} synchronization period, and K denotes a quantity of times of training of the target local recognition model in the r^{th} synchronization period.

The target client in the embodiments of this application is any one of the N clients. Content corresponding to the target client is all applicable to other clients among the N clients.

In some embodiments, the multimedia sample data includes face sample data, the target object type includes a face type, and the object recognition model obtained through training based on the above multimedia sample data is configured to perform face recognition on a face image to be recognized.

Schematically, a process of performing, by the target client, face recognition based on the object recognition model includes:
acquiring, by the target client, the face image to be recognized;
inputting the face image to be recognized into the object recognition model, and acquiring a face space feature corresponding to the face image to be recognized outputted by the object recognition model; and
determining a face classification result corresponding to the face image to be recognized according to the face space feature. The face classification result is used for representing an identity verification result of an object of the face type included in the face image to be recognized.

For example, in a scenario of verifying identity of visitors to an enterprise, the enterprise may manage access permissions of enterprise employees. That is, there is a need to verify identity of the visitors to the enterprise. The visitor passing the identity verification can enter the enterprise, and the visitor not passing the identity verification cannot enter the enterprise. The above identity verification process may be implemented through the object recognition model obtained in the embodiments of this application. When a location of a person A is within an effective space region of an image collection device (the image collection device may be implemented as a camera or a camera component) corresponding to a terminal device, the terminal device may start the image collection device to collect a real-time face image of the person A (it may be understood that the above client may be integrated in the terminal device, the terminal device may pre-collect a face image of the person A, and use the above object recognition model to acquire face feature information of the face image, and both the pre-collected face image and the face feature information thereof may be stored in the above client). The client may use the collected real-time face image as the face image to be recognized, input the face image to be recognized into the object recognition model, acquire a face space feature corresponding to the face image to be recognized inputted by the object recognition model, and compare the face space feature with face feature information pre-stored in the client. If the face space feature matches the face feature information pre-stored in the client, it may be determined that the face image to be recognized is a valid face, indicating that the person A passes the identity verification and has a permission to enter the enterprise. If the face space feature does not match the face feature information pre-stored in the client, it may be determined that the face image to be recognized is an invalid face, indicating that the person A does not pass the identity verification and has no permission to enter the enterprise. “The face space feature matches the face feature information pre-stored in the client” means that a similarity between the face space feature and the face feature information pre-stored in the client is greater than or equal to a similarity threshold. Correspondingly, “the face space feature does not match the face feature information pre-stored in the client” means that the similarity between the face space feature and the face feature information pre-stored in the client is less than the similarity threshold.

In some embodiments, the terminal device is a device with an image display function. When the real-time face image is collected, the collected real-time face image may be displayed on a terminal screen of the above terminal device.

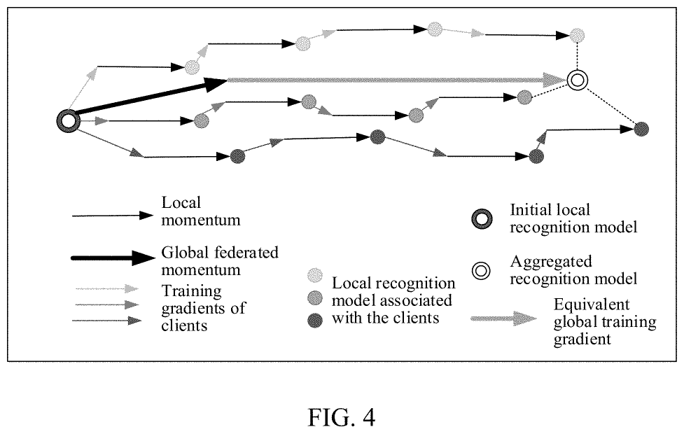

FIG. 4 is a schematic diagram of a method for training local recognition models based on global federated momentum according to an embodiment of this application. As shown in FIG. 4, the service device may provide an initial local recognition model for each of the N clients. Structures and parameters of the initial local recognition models obtained by the clients are the same. The clients may use the multimedia sample data stored locally to iteratively train the initial local recognition models. As shown in FIG. 4, the clients have respective corresponding training gradients. The training gradients may be calculated according to the formula (1). Details are not described herein again. In the process of training, by the clients, the local recognition models associated therewith, training directions corresponding to the local recognition models may be guided through the global federated momentum and an equivalent global training gradient (i.e., aggregation of the training gradients corresponding to the clients), to ensure that convergence directions of the local recognition models associated with the clients are as close as possible to a global convergence direction. When a quantity of times of iterative training reaches the quantity of times of periodic training corresponding to the synchronization period, the clients may upload, through the corresponding user terminal, local model parameters of the local recognition models corresponding thereto to the service device when the quantity of times of periodic training is reached.

The service device, after receiving the local model parameters of the local recognition models transmitted by the N clients, may determine global federated momentum according to the local model parameters, and perform parameter fusion on the local model parameters to obtain an aggregated recognition model (i.e., a target global model). The service device, after obtaining global federated momentum corresponding to a current synchronization period, may transmit the global federated momentum corresponding to the synchronization period and a model parameter corresponding to the aggregated recognition model to the clients. After the clients receive the global federated momentum and the model parameter corresponding to the aggregated recognition model transmitted by the service device, unit federated momentum may be determined according to the global federated momentum and the quantity of times of periodic training. The clients perform parameter update on the local recognition models associated therewith according to the unit federated momentum, the training learning rates, and training gradients. In addition, the clients may use the model parameter corresponding to the aggregated recognition model as a reference basis, to better perform parameter update on the local recognition models associated therewith. Therefore, training directions of the local recognition models associated with the clients are controlled through the global federated momentum, which ensures that the convergence directions of the local recognition models corresponding to the clients may not deviate too far from the global convergence direction. That is, the convergence directions of the local recognition models associated with the clients may not deviate too far from each other, thereby reducing a client drift phenomenon. In other words, the problem of slow and unstable convergence of finally obtained object recognition models caused by inconsistent optimization directions of the local recognition models associated with the clients is alleviated.

The local recognition models after the parameter update may be determined as the object recognition models when the local recognition models in the clients meet the training termination condition. The training termination condition may mean that a quantity of training periods of the local recognition models reach a defaulted quantity of termination periods. For example, when r is 1000, parameter update is performed on the local recognition models associated with the clients according to a target global model corresponding to the 1000^{th} synchronization period to obtain local recognition models after the parameter update. Then, the local recognition models after the parameter update may be determined as object recognition models. Alternatively, the training termination condition may refer to quantities of training iterations corresponding to the clients. For example, when quantities of training steps corresponding to the clients are a quantity of target training iterations, it may be determined that the local recognition models after the parameter update in the clients meet the training termination condition. The local recognition models after the parameter update obtained when the quantities of training iterations are met are determined as object recognition models. Specific content shown in FIG. 4 may be obtained with reference to the content in S101 to S107. Details are not described herein again.

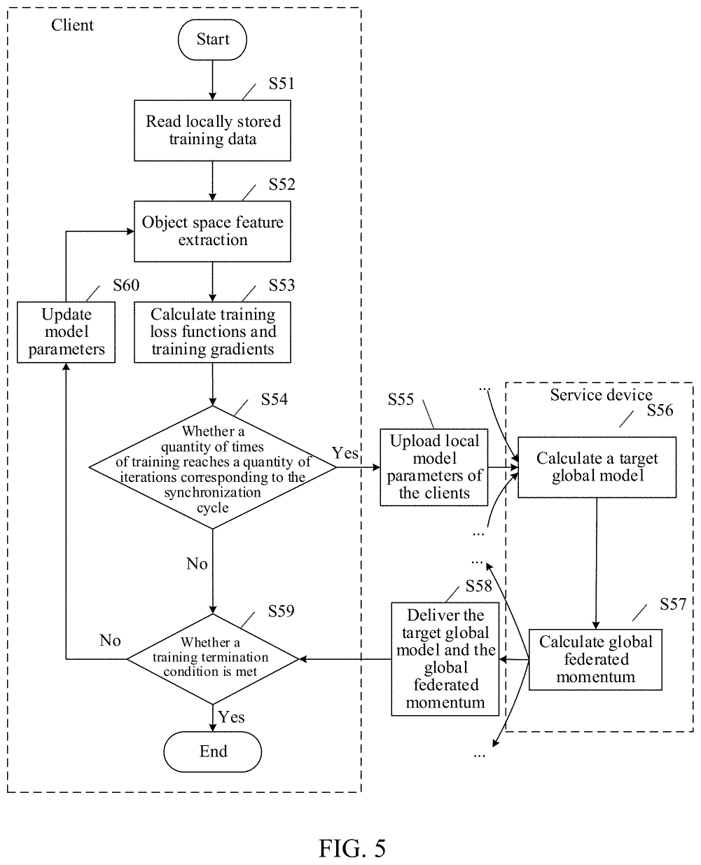

FIG. 5 is a schematic diagram of a method for training local recognition models based on global federated momentum according to an embodiment of this application. As shown in FIG. 5, clients may read locally stored training data S51, and process the training data (i.e., multimedia sample data) in batches to obtain one or more training data files (batch), such as a first training data file X₁ and a second training data file X₂. A training data file may be used for one iterative training on local recognition models within a synchronization period. The training data in the training data file is inputted into the local recognition models, and object space feature extraction is performed S52, to obtain object space features corresponding to the training data. If the training data is face image data, space feature extraction may be performed on the face image data to obtain a feature map that retains spatial structure information of a face image. Feature extraction may be performed on the training data by using a CNN. After the clients obtains the object space features corresponding to the training data, training loss functions and training gradients corresponding to the local recognition models may be calculated S53. After completion of each iterative training of the local recognition models, it is determined whether current quantities of times of training reach a quantity of iterations corresponding to the synchronization period S54. The training is continued if the current quantities of times of training of the local recognition models do not reach the quantity of iterations corresponding to the synchronization period. If the current quantities of times of training of the local recognition models reach the quantity of iterations corresponding to the synchronization period, local model parameters of the local recognition models when the quantity of iterations corresponding to the synchronization period is reached are uploaded to the service device S55.

The service device, after receiving a local model parameter uploaded by each client in a current synchronization period, may perform parameter fusion on the local model parameter uploaded by each client to obtain a target global model S56. The service device may also calculate, according to a historical global model corresponding to a previous synchronization period and a present target global model corresponding to the synchronization period, global federated momentum corresponding to the present synchronization period S57. The service device, after obtaining the target global model and the global federated momentum, may transmit the target global model and the global federated momentum to the clients S58. After the clients receive the target global model and the global federated momentum transmitted by the service device, it may be determined whether the target global model meets a training termination condition S59. If the training termination condition is met, the training is ended, and the target global model is used as an object recognition model. The object recognition model is configured to recognize an object of a target object type. If the training termination condition is not met, parameter update is performed on the local recognition models of the clients according to the target global model and the global federated momentum S60, to obtain local recognition models after the parameter update, and the local recognition models after the parameter update are continuously trained until the training termination condition is met. If the training termination condition is that a training synchronization period meets a target synchronization period, it may be determined whether the current synchronization period meets the target synchronization period after the clients receive the target global model and the global federated momentum transmitted by the service device. If the current synchronization period meets the target synchronization period, it is determined that the training termination condition is met. Then, model training is ended, and the target global model transmitted by the service device in the current synchronization period is used as an object recognition model. If the current synchronization period does not meet the target synchronization period, parameter update is performed on the local recognition models according to the target global model and the global federated momentum transmitted by the service device, and local recognition models after the parameter update are continuously trained until a synchronization period meets the target synchronization period. Specific content of steps S51 to S60 shown in FIG. 5 may be obtained with reference to the above related content in S101 to S107. Details are not described herein again.

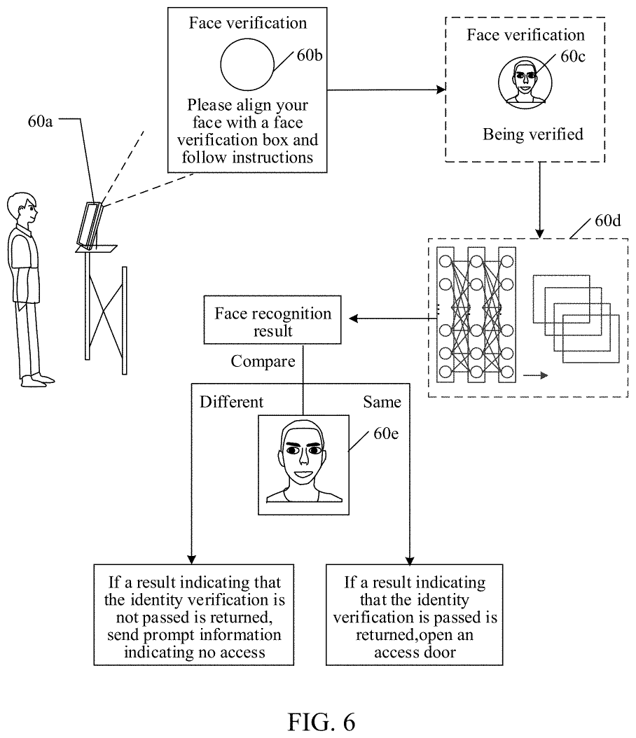

FIG. 6 is a schematic structural diagram of a user identity authentication scenario according to an embodiment of this application. As shown in FIG. 6, when the object recognition model is a model obtained through training based on face sample data, that is, when the multimedia sample data is the face sample data, in an application scenario of the object recognition model, when a user A wants to enter an enterprise where access permissions are restricted, identity verification needs to be performed on the user A. An access door may be opened only after the identity verification is passed, allowing the user A to enter the enterprise. As shown in FIG. 6, a face image of the user A may be collected through a client 1 installed on a user terminal 60a, to obtain face image data corresponding to the user A. The user A may align the face with a detection frame 60b of the client 1, so that the face appears in the detection frame 60b, which facilitates collection of the user A's full face information. The client 1 may acquire face data 60c in the detection frame 60b in real time to obtain face data to be recognized. The client 1, after collecting the face data to be recognized 60c, may input the face data to be recognized 60c into an object recognition model 60d, so that the object recognition model 60d performs feature extraction on the face data to be recognized 60c to obtain an object space feature corresponding to the user A, that is, a face recognition result. In addition, the client 1 may detect whether a face image matching the user A exists in an existing face image database. If the user A's face image does not exist in the face image database, a result indicating that the identity verification is not passed is directly returned, prompting that the user A is prohibited to enter. If the user A's face image 60e exists in the face image database, the face image 60e is compared with the face recognition result outputted by the object recognition model 60d. If the face image 60e matches the face recognition result, it may be determined that the user A passes the identity verification, a result indicating that the identity verification is passed is returned to the client 1, and the access door is opened. If the face image 60e does not match the face recognition result, it may be determined that the user A does not pass the identity verification, and a result indicating that the identity verification is not passed is returned to the client 1, reminding the user A that access is prohibited.

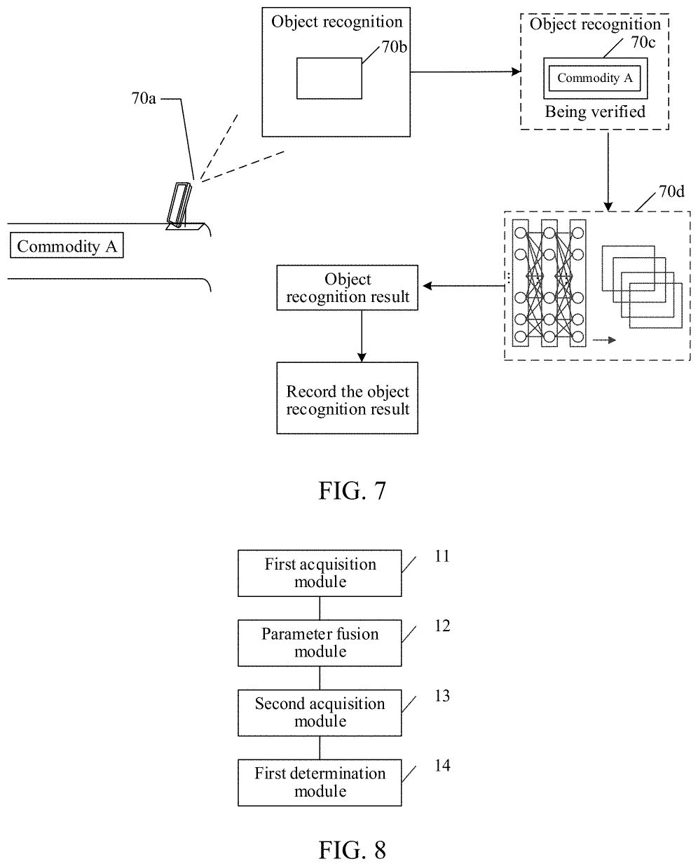

FIG. 7 is a schematic diagram of a commodity recognition scenario according to an embodiment of this application. As shown in FIG. 7, when the object recognition model is a model obtained through training based on commodity sample data, that is, when the multimedia sample data is the commodity sample data, object recognition may be performed on a commodity on a conveyor belt through a client 2 installed on a user terminal 70a, to obtain attribute information corresponding to the commodity, such as a commodity type, a commodity size, and a commodity quantity, and the attribute information is recorded to facilitate subsequent management. When the user terminal 70a detects appearance of the commodity, the commodity on the conveyor belt may be displayed in the detection frame 70b, commodity image data 70c corresponding to the commodity on the conveyor belt is collected in real time, and the commodity image data collected in real time is determined as image data to be recognized. Feature extraction is performed on the image data to be recognized in an object recognition model 70d, to obtain an object recognition result corresponding to the image data to be recognized, and the object recognition result is recorded to facilitate subsequent management of the commodity. For example, a quantity of the commodity is acquired to facilitate timely production and so on.

According to the data processing method in this application, the service device periodically acquires local model parameters respectively uploaded by the N clients, generates a target global model and global federated momentum according to the local model parameters, and transmits the target global model and the global federated momentum to the N clients to control training directions of the local recognition models respectively trained by the N clients, so that convergence directions of the local recognition models corresponding to the clients may not deviate too far from each other, which can improve performance of an object recognition model finally obtained and improve applicability of the object recognition model.

FIG. 8 is a schematic structural diagram of a data processing apparatus according to an embodiment of this application. The apparatus is applicable to a service device. As shown in FIG. 8, the data processing apparatus may include:
a first acquisition module 11 configured to acquire local model parameters corresponding to N local recognition models in an r^{th} synchronization period; the N local recognition models being respectively trained by different clients, each of the clients including sample data for training an associated local recognition model, both N and r being positive integers greater than 1, and N denoting a quantity of the clients;
a parameter fusion module 12 configured to perform parameter fusion on the local model parameters respectively corresponding to the N local recognition models to obtain a target global model corresponding to the r^{th} synchronization period;
a second acquisition module 13 configured to acquire a historical global model corresponding to an r−1^{th} synchronization period; the historical global model being generated based on local model parameters respectively uploaded by N clients in the r−1^{th} synchronization period;
a first determination module 14 configured to determine global federated momentum corresponding to the r^{th} synchronization period according to the historical global model and the target global model; the global federated momentum being used for indicating training directions of the N local recognition models; and
a transmission module configured to transmit the global federated momentum to the N clients, so that the N clients respectively perform parameter update on the associated local recognition models according to the global federated momentum.

In some embodiments, the sample data is multimedia sample data, the multimedia sample data including an object of a target object type; and
the apparatus further includes:
a third acquisition module configured to acquire, in response to the N local recognition models reaching a training termination condition, the local recognition models reaching the training termination condition as object recognition models; the object recognition models being configured to recognize the object of the target object type included in the multimedia sample data.

In some embodiments, the first determination module 14 includes:
a first acquisition unit configured to acquire training learning rates of the N local recognition models in the r^{th} synchronization period and a model parameter difference between the target global model and the historical global model; and
a first determination unit configured to determine a ratio of the model parameter difference to the training learning rates as the global federated momentum.

In some embodiments, the parameter fusion module 12 includes:
a second acquisition unit configured to acquire M local model parameters from the local model parameters respectively corresponding to the N local recognition models; M being a positive integer less than N;
a third acquisition unit configured to acquire training influence weights respectively corresponding to the M local model parameters; and
a second determination unit configured to perform weighted summation on the training influence weights and the M local model parameters to obtain a fusion model parameter, and determine a model carrying the fusion model parameter as the target global model.

According to the embodiments of this application, through the service device, local model parameters respectively uploaded by the N clients are periodically acquired, a target global model and global federated momentum are generated according to the local model parameters, and the target global model and the global federated momentum are transmitted to the N clients to control training directions of the local recognition models respectively trained by the N clients, so that convergence directions of the local recognition models corresponding to the clients may not deviate too far from each other, which can improve performance of an object recognition model finally obtained and improve applicability of the object recognition model.

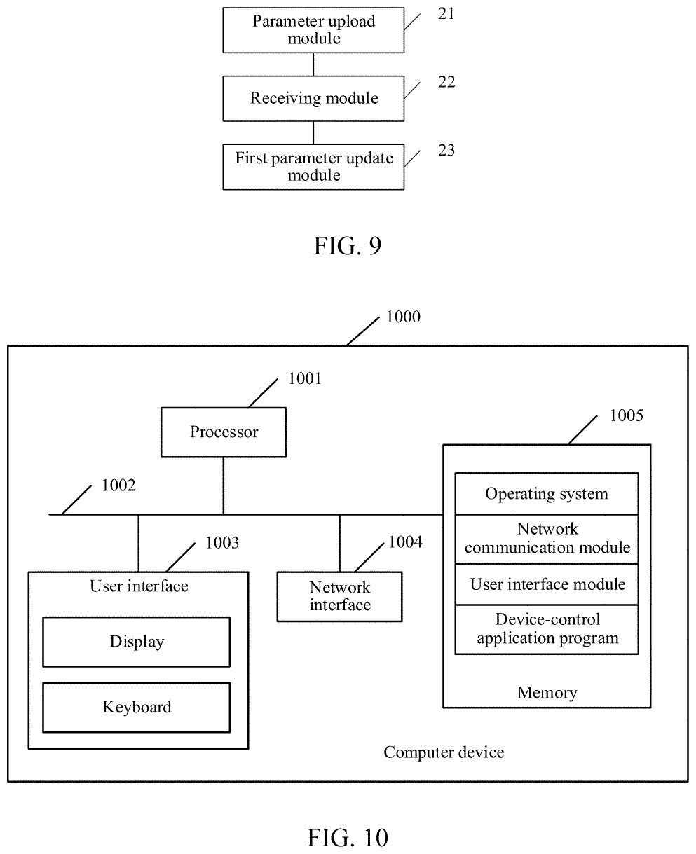

FIG. 9 is a schematic structural diagram of a data processing apparatus according to an embodiment of this application. The apparatus is applicable to a user terminal. As shown in FIG. 9, the data processing apparatus may include:
a parameter upload module 21 configured to upload, when a target local recognition model completes training of an r^{th} synchronization period, a local model parameter corresponding to the target local recognition model to a service device, so that the service device generates a target global model according to local model parameters respectively uploaded by N clients in the r^{th} synchronization period, and determines global federated momentum corresponding to the r^{th} synchronization period by combining the target global model with a historical global model corresponding to an r−1^{th} synchronization period; the target local recognition model being any one of local recognition models corresponding to the N clients, the historical global model being generated based on local model parameters respectively uploaded by the N clients in the r−1^{th} synchronization period, the global federated momentum being used for indicating training directions of the N local recognition models, both N and r being positive integers greater than 1;
a receiving module 22 configured to receive the global federated momentum returned by the service device; and
a first parameter update module 23 configured to perform parameter update on the target local recognition model according to the global federated momentum.

In some embodiments, the target local recognition model is trained based on multimedia sample data; the multimedia sample data including an object of a target object type; and
the apparatus further includes:
a fourth acquisition module configured to acquire, in response to the target local recognition model reaching a training termination condition, the target local recognition model reaching the training termination condition as an object recognition model; the object recognition model being configured to recognize the object of the target object type included in the multimedia sample data.

In some embodiments, the apparatus further includes:
an input module configured to acquire the multimedia sample data, and input the multimedia sample data into the target local recognition model;
a fifth acquisition module configured to acquire an object space feature corresponding to the multimedia sample data outputted by the target local recognition model;
a second determination module configured to determine a function value of a training loss function corresponding to the target local recognition model according to the object space feature and label information corresponding to the sample data;
a gradient determination module configured to determine a training gradient of the target local recognition model according to the function value of the training loss function; and
a second parameter update module configured to perform parameter update on the target local recognition model according to the training gradient and a training learning rate corresponding to the target local recognition model.

In some embodiments, the first parameter update module 23 includes:
a fourth acquisition unit configured to acquire a training gradient and a training learning rate corresponding to the target local recognition model in the r^{th} synchronization period;
a third determination unit configured to determine a ratio of the global federated momentum to the quantity of times of periodic training as unit federated momentum; and
a parameter update unit configured to perform parameter update on the target local recognition model according to the training learning rate, the training gradient, and the unit federated momentum.

In some embodiments, the multimedia sample data includes face sample data, and the target object type includes a face type; the object recognition model is configured to perform face recognition on a face image to be recognized; and
the apparatus further includes:
a sixth acquisition module configured to acquire the face image to be recognized;
a seventh acquisition module configured to input the face image to be recognized into the object recognition model, and acquire a face space feature corresponding to the face image to be recognized outputted by the object recognition model; and
a third determination module configured to determine a face classification result corresponding to the face image to be recognized according to the face space feature; the face classification result being used for representing an identity verification result of an object of the face type included in the face image to be recognized.

According to the embodiments of this application, through the user terminal, when the quantity of times of training of the target local recognition model meets the r^{th} synchronization period, a local model parameter corresponding to the target local recognition model is uploaded to the service device, so that the service device periodically acquires local model parameters respectively uploaded by the N clients, generates a target global model and global federated momentum according to the local model parameters, and transmits the target global model and the global federated momentum to the N clients to control training directions of the local recognition models respectively trained by the N clients, and convergence directions of the local recognition models corresponding to the clients may not deviate too far from each other, which can improve performance of an object recognition model finally obtained and improve applicability of the object recognition model.

FIG. 10 is a schematic structural diagram of a computer device according to an embodiment of this application. As shown in FIG. 10, the computer device 1000 may include: a processor 1001, a network interface 1004, and a memory 1005. In addition, the above computer device 1000 may further include: a user interface 1003, and at least one communication bus 1002. The communication bus 1002 is configured to implement connection and communication between these components. The user interface 1003 may include a display and a keyboard. In some embodiments, the user interface 1003 may further include a standard wired interface and a standard wireless interface. In some embodiments, the network interface 1004 may include a standard wired interface and a standard wireless interface (such as a Wi-Fi interface). The memory 1005 may be a high-speed random access memory (RAM), or a non-volatile memory (NVM), such as at least one disk memory. In some embodiments, the memory 1005 may alternatively be at least one storage apparatus located away from the foregoing processor 1001. As shown in FIG. 10, the memory 1005 used as a computer-readable storage medium may include an operating system, a network communication module, a user interface module, and a device-control application program.

In the computer device 1000 shown in FIG. 10, the network interface 1004 may provide a network communication function. The user interface 1003 is mainly configured to provide an input interface for a user. The processor 1001 may be configured to invoke the device-control application program stored in the memory 1005 to perform the following operations:
acquiring local model parameters corresponding to N local recognition models in an r^{th} synchronization period; the N local recognition models being independently trained by different clients respectively, each of the clients including multimedia sample data for training an associated local recognition model, the multimedia sample data including an object of a target object type, both N and r being positive integers greater than 1, and N denoting a quantity of the clients;
performing parameter fusion on the local model parameters respectively corresponding to the N local recognition models to obtain a target global model corresponding to the r^{th} synchronization period;
acquiring a historical global model of the N local recognition models in an r−1^{th} synchronization period, and generating global federated momentum corresponding to the r^{th} synchronization period according to the historical global model and the target global model; the historical global model being generated based on local model parameters respectively uploaded by N clients in the r−1^{th} synchronization period, the global federated momentum being used for indicating training directions of the N local recognition models; and
transmitting the global federated momentum to the N clients, so that the N clients respectively perform parameter update on the associated local recognition models according to the global federated momentum, to obtain object recognition models; the object recognition models being configured to recognize the object of the target object type included in the multimedia data.

It is to be understood that the computer device 1000 described in the embodiments of this application may perform the data processing method in the foregoing embodiment corresponding to FIG. 3. Details are not described herein again.

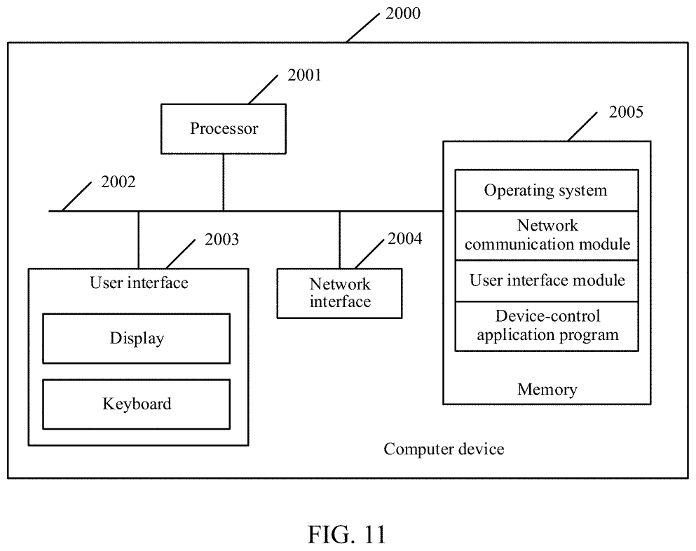

FIG. 11 is a schematic structural diagram of a computer device according to an embodiment of this application. As shown in FIG. 11, the computer device 2000 may include: a processor 2001, a network interface 2004, and a memory 2005. In addition, the above computer device 2000 may further include: a user interface 2003, and at least one communication bus 2002. The communication bus 2002 is configured to implement connection and communication between these components. The user interface 2003 may include a display and a keyboard. In some embodiments, the user interface 2003 may further include a standard wired interface and a standard wireless interface. In some embodiments, the network interface 2004 may include a standard wired interface and a standard wireless interface (such as a Wi-Fi interface). The memory 2005 may be a high-speed RAM, or an NVM, such as at least one disk memory. In some embodiments, the memory 2005 may alternatively be at least one storage apparatus located away from the foregoing processor 2001. As shown in FIG. 11, the memory 2005 used as a computer-readable storage medium may include an operating system, a network communication module, a user interface module, and a device-control application program.

In the computer device 2000 shown in FIG. 11, the network interface 2004 may provide a network communication function. The user interface 2003 is mainly configured to provide an input interface for a user. The processor 2001 may be configured to invoke the device-control application program stored in the memory 2005 to perform the above data processing method.

It is to be understood that the computer device 2000 described in the embodiments of this application can perform the data processing method in the embodiment corresponding to FIG. 3. Details are not described herein again.

An embodiment of this application further provides a computer-readable storage medium. The computer-readable storage medium stores a computer program including a program instruction. A processor can perform the data processing method in the embodiment shown in FIG. 3 when executing the program instruction.

For technical details that are not disclosed in the computer-readable storage medium embodiments of this application, refer to the descriptions of the method embodiments of this application. By way of example, the program instruction may be deployed to be executed by one computing device, or by a plurality of computing devices at a same location, or by a plurality of computing devices distributed at a plurality of locations and interconnected via a communication network. The plurality of computing devices distributed at the plurality of locations and interconnected via the communication network can form a block chain system.

An embodiment of this application further provides a computer program product or computer program. The computer program product or computer program may include a computer instruction that may be stored in a computer-readable storage medium. A processor of a computer device reads the computer instruction from the computer-readable storage medium. The processor may execute the computer instruction to cause the computer device to perform the data processing method according to the embodiments of this application. For technical details that are not disclosed in the computer program product or computer program embodiments of this application, refer to the descriptions of the method embodiments of this application.

To simplify the description, the foregoing method embodiments are described as a series of action combinations. But it is to be known by a person of ordinary skill in the art that this application is not limited to any described sequence of the actions, as some steps can be performed in other sequences or simultaneously according to this application. In addition, it is also to be known by a person of ordinary skill in the art that all the embodiments described in the specification are exemplary embodiments, and the related actions and modules are not necessarily mandatory to this application.

Steps in the methods in the embodiments of this application may be adjusted in sequence, combined, or deleted according to an actual requirement.

Modules in the apparatuses in the embodiments of this application may be combined, divided, or deleted according to an actual requirement.

A person of ordinary skill in the art may understand that all or some procedures in the methods in the foregoing embodiments may be implemented by a computer program instructing relevant hardware. The computer program may be stored in a computer-readable storage medium. When being executed, the program may include the procedures according to the embodiments of the foregoing methods. The storage medium may be a magnetic disk, an optical disc, a read-only memory (ROM), an RAM, or the like.

The foregoing descriptions are merely exemplary embodiments of this application, and certainly are not intended to limit the scope of the claims of this application. Therefore, equivalent variations made in accordance with the claims of this application shall still fall within the scope of this application.

What is claimed is:

1. A data processing method, performed by a service device, the method comprising:
acquiring local model parameters corresponding to N local recognition models in an r^{th} synchronization period; the N local recognition models being respectively trained by different clients, each client comprising sample data for training an associated local recognition model, both N and r being positive integers greater than 1, and N denoting a quantity of the clients;
performing parameter fusion on the local model parameters respectively corresponding to the N local recognition models to obtain a target global model corresponding to the r^{th} synchronization period;
acquiring a historical global model corresponding to an r−1^{th} synchronization period; the historical global model being generated based on local model parameters respectively uploaded by N clients in the r−1^{th} synchronization period;
determining global federated momentum corresponding to the r^{th} synchronization period according to the historical global model and the target global model; the global federated momentum indicating training directions of the N local recognition models; and
transmitting the global federated momentum to the N clients, the N clients respectively updating the associated local recognition models according to the global federated momentum.

2. The method according to claim 1, wherein the sample data is multimedia sample data, the multimedia sample data comprising an object of a target object type; and
the method further comprises:
acquiring, in response to the N local recognition models reaching a training termination condition, the local recognition models reaching the training termination condition as object recognition models; the object recognition models being configured to recognize the object of the target object type in the multimedia sample data.

3. The method according to claim 1, wherein the determining global federated momentum corresponding to the r^{th} synchronization period according to the historical global model and the target global model comprises:
acquiring training learning rates of the N local recognition models in the r^{th} synchronization period and a model parameter difference between the target global model and the historical global model; and
determining a ratio of the model parameter difference to the training learning rates as the global federated momentum.

4. The method according to claim 1, wherein the performing parameter fusions on the local model parameters respectively corresponding to the N local recognition models to obtain a target global model corresponding to the r^{th} synchronization period comprises:
acquiring M local model parameters from the local model parameters respectively corresponding to the N local recognition models; M being a positive integer less than N;
acquiring training influence weights respectively corresponding to the M local model parameters; and
performing weighted summation on the training influence weights and the M local model parameters to obtain a fusion model parameter, and determining a model carrying the fusion model parameter as the target global model.

5. A data processing method, performed by a user terminal, the method comprising:
uploading a local model parameter corresponding to the target local recognition model to a service device when a target local recognition model completes training of an r^{th} synchronization period, wherein the service device generates a target global model according to local model parameters respectively uploaded by N clients in the r^{th} synchronization period, and determines global federated momentum corresponding to the r^{th} synchronization period by combining the target global model with a historical global model corresponding to an r−1^{th} synchronization period; the target local recognition model being one of local recognition models corresponding to the N clients, the historical global model being generated based on local model parameters respectively uploaded by the N clients in the r−1^{th} synchronization period, the global federated momentum indicating training directions of the N local recognition models, both N and r being positive integers greater than 1;
receiving the global federated momentum returned by the service device; and
updating the target local recognition model according to the global federated momentum.

6. The method according to claim 5, wherein the target local recognition model is trained based on multimedia sample data; the multimedia sample data comprising an object of a target object type.

7. The method according to claim 6, wherein the method further comprises:
acquiring, in response to the target local recognition model reaching a training termination condition, the target local recognition model reaching the training termination condition as an object recognition model; the object recognition model being configured to recognize the object of the target object type in the multimedia sample data.

8. The method according to claim 7, wherein the method further comprises:
acquiring the multimedia sample data, and inputting the multimedia sample data into the target local recognition model;
acquiring an object space feature corresponding to the multimedia sample data outputted by the target local recognition model;
determining a function value of a training loss function corresponding to the target local recognition model according to the object space feature and label information corresponding to the sample data;
determining a training gradient of the target local recognition model according to the function value of the training loss function; and
updating the target local recognition model according to the training gradient and a training learning rate corresponding to the target local recognition model.

9. The method according to claim 5, wherein the updating parameters of the target local recognition model according to the global federated momentum comprises:
acquiring a training gradient and a training learning rate corresponding to the target local recognition model in the r^{th} synchronization period;
acquiring a quantity of times of periodic training of the target local recognition model in the r^{th} synchronization period;
determining a ratio of the global federated momentum to the quantity of times of periodic training as unit federated momentum; and
updating the target local recognition model according to the training learning rate, the training gradient, and the unit federated momentum.

10. The method according to claim 6, wherein the multimedia sample data comprises face sample data, and the target object type comprises a face type; the object recognition model is configured to perform face recognition on a face image to be recognized.

11. The method according to claim 10, wherein the method further comprises:
acquiring the face image to be recognized;
inputting the face image to be recognized into the object recognition model, and acquiring a face space feature corresponding to the face image to be recognized outputted by the object recognition model; and
determining a face classification result corresponding to the face image to be recognized according to the face space feature.

12. The method according to claim 11, wherein the face classification result represents an identity verification result of an object of the face type in the face image to be recognized.

13. A non-transitory computer-readable storage medium, storing a computer program adapted to be loaded and executed by a processor to implement a data processing method performed by a user terminal, the method comprising:
uploading a local model parameter corresponding to the target local recognition model to a service device when a target local recognition model completes training of an r^{th} synchronization period, wherein the service device generates a target global model according to local model parameters respectively uploaded by N clients in the r^{th} synchronization period, and determines global federated momentum corresponding to the r^{th} synchronization period by combining the target global model with a historical global model corresponding to an r−1^{th} synchronization period; the target local recognition model being one of local recognition models corresponding to the N clients, the historical global model being generated based on local model parameters respectively uploaded by the N clients in the r−1^{th} synchronization period, the global federated momentum indicating training directions of the N local recognition models, both N and r being positive integers greater than 1;
receiving the global federated momentum returned by the service device; and
updating the target local recognition model according to the global federated momentum.

14. The computer-readable storage medium according to claim 13, wherein the sample data is multimedia sample data, the multimedia sample data comprising an object of a target object type.

15. The computer-readable storage medium according to claim 14, wherein the method further comprises:
acquiring, in response to the N local recognition models reaching a training termination condition, the local recognition models reaching the training termination condition as object recognition models; the object recognition models being configured to recognize the object of the target object type in the multimedia sample data.

16. The computer-readable storage medium according to claim 15, wherein the method further comprises:
acquiring the multimedia sample data, and inputting the multimedia sample data into the target local recognition model;
acquiring an object space feature corresponding to the multimedia sample data outputted by the target local recognition model;
determining a function value of a training loss function corresponding to the target local recognition model according to the object space feature and label information corresponding to the sample data;
determining a training gradient of the target local recognition model according to the function value of the training loss function; and
updating the target local recognition model according to the training gradient and a training learning rate corresponding to the target local recognition model.

17. The computer-readable storage medium according to claim 13, wherein the updating parameters of the target local recognition model according to the global federated momentum comprises:
acquiring a training gradient and a training learning rate corresponding to the target local recognition model in the r^{th} synchronization period;
acquiring a quantity of times of periodic training of the target local recognition model in the r^{th} synchronization period;
determining a ratio of the global federated momentum to the quantity of times of periodic training as unit federated momentum; and
updating the target local recognition model according to the training learning rate, the training gradient, and the unit federated momentum.

18. The computer-readable storage medium according to claim 14, wherein the multimedia sample data comprises face sample data, and the target object type comprises a face type; the object recognition model is configured to perform face recognition on a face image to be recognized.

19. The computer-readable storage medium according to claim 18, wherein the method further comprises:
acquiring the face image to be recognized;
inputting the face image to be recognized into the object recognition model, and acquiring a face space feature corresponding to the face image to be recognized outputted by the object recognition model; and
determining a face classification result corresponding to the face image to be recognized according to the face space feature.

20. The computer-readable storage medium according to claim 19, wherein the face classification result represents an identity verification result of an object of the face type in the face image to be recognized.
